(19) United States
(12) Patent Application Publication
(10) Pub. No.: US 2003/0169768 A1
(43) Pub. Date: Sep. 11, 2003

(54) Call initiation for legacy mobile circuit switched domain wireless systems

(75) Inventors: Marvin Bienn, Dallas, TX (US); Jayshree A. Bharatia, Plano, TX (US); Amy Pendleton, Dallas, TX (US)

Correspondence Address: Gregory W. Carr, CARR LAW FIRM, L.L.P., 670 Founders Square, 900 Jackson Street, Dallas, TX, 75202, US

(73) Assignee: Nortel Networks Limited, St. Laurent (CA)

(21) Appl. No.: 10/326,345

(22) Filed: Dec. 20, 2002

Related U.S. Application Data
(60) Provisional application No. 60/362,607, filed on Mar. 8, 2002.

(51) Int. Cl. H04J 3/16

(52) U.S. Cl. 370/469; 370/395.5

(57) ABSTRACT

The present invention provides a packet-switched telecommunications system having at least a first network and a second network that employ packet-switched protocol, and a third network employing circuit-switched protocol. A first functional entity and a second functional entity are employed within each of the first and second networks. The first and functional entities of both networks have an interworking engine, which allows for the communication between a circuit-switched network and a packet-switched network. The second functional entities of both networks communicate using device control protocol.

### CROSS-REFERENCED APPLICATION

This application relates to co-pending U.S. provisional patent application Serial No. 60/362,607, filed Mar. 8, 2002, and entitled “Call Invocation to an Idle MS on Another MSCE,” the contents of which are incorporated by reference.

### FIELD OF THE INVENTION

The present invention relates to the handling of legacy circuit-switched domain calls in a packet-switched telecommunications protocol and, more particularly, to call initiation in the mobile network where interworking between the circuit-switched and packet-switched network is performed.

### BACKGROUND

In circuit-switched (CS) mobile telecommunications systems, a mobile station (MS) sends a signal or message, which is picked up by a base transmitting station (BTS) and then routed by a base station controller (BSC). The signal or message is forwarded by the BSC to an associated mobile switching center (MSC), for routing to the appropriate destination, for example, a public switched telephone network (PSTN) or other telecommunications node or network).

To increase multimedia and Internet capabilities, and for other reasons, most mobile telecommunications systems are being migrated from use of a circuit-switched core network to use of a packet-switched (PS) protocol network. Systems using a PS network nevertheless typically needs support for handling calls routed through non-PN systems (for example, PSTN). Ideally, support for existing mobile stations (MS's), for example, call initiation, call termination, in a PS signaling network environment will operate in a manner transparent to the user. Furthermore, ideally, such support should also permit supporting new features and capabilities. However, end users are often stymied by a lack of standardization to enable such migration from circuit-switched networks to packet-switched mobile networks to continue.

Therefore, what is needed is call initiation between a circuit switched network and a PS network for communicating with a mobile station.

### SUMMARY OF THE INVENTION

The present invention provides a first network employing circuit control protocol. A second and third network employs packet data control protocol. A packet call control entity has an interworking engine. The interworking engine is employable to receive communication from the first network and forward the communication to the third network, through employment of a conversion of the circuit control protocol to the packet data control protocol.

### BRIEF DESCRIPTION OF THE DRAWINGS

For a more complete understanding of the present invention, and the advantages thereof, reference is now made to the following description taken in conjunction with the accompanying drawings, in which:

FIG. 1 is a functional block diagram depicting a PS network, having a Legacy Mobile Station Domain Support (LMSDS), in communication with another PS network having a LMSDS;

FIG. 2 is a block diagram depicting a protocol stack for reference point zz of FIG. 1; and

FIGS. 3A and 3B illustrate a nodal analysis depicting an example of call initiation by a mobile station.

### DETAILED DESCRIPTION

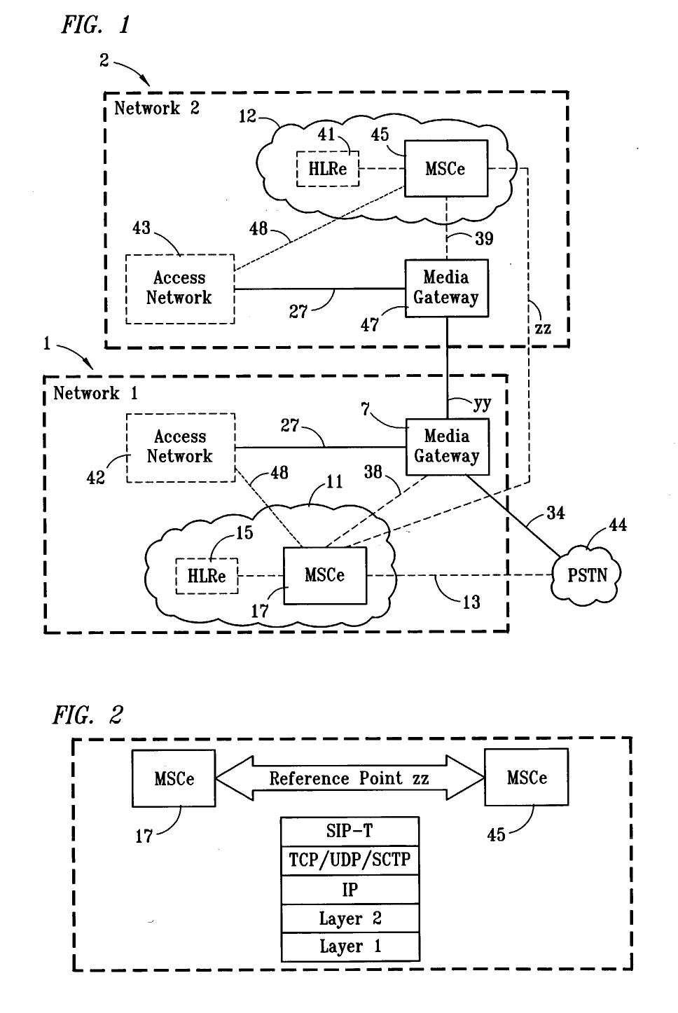

Turning now to FIG. 1, a system for handling circuit-switched operations in a telecommunications system having a PS network is depicted. In the following discussion, numerous specific details are set forth to provide a thorough understanding of the present invention. However, it will be obvious to those skilled in the art that the present invention can be practiced without such specific details. In other instances, well-known elements have been illustrated in schematic or block diagram form in order not to obscure the present invention in unnecessary detail. Additionally, for the most part, details concerning CDMA systems and the like have been omitted inasmuch as such details are not considered necessary to obtain a complete understanding of the present invention, and are considered to be within the skills of persons of ordinary skill in the relevant art.

It is further noted that, unless indicated otherwise, all functions described herein are performed by a processor such as a computer or electronic data processor in accordance with code such as computer program code, software, and/or integrated circuits that are coded to perform such functions.

FIG. 1 illustrates first and second PS networks 1 and 2 in communication with one another across reference points yy and zz. Network 1 includes Legacy Mobile Station Domain Support (LMSDS) 11, which includes a home location register emulator (HLRe) 15 and a PS call control entity, such as a mobile switching control emulator (MSCe) 17. An LMSDS can be generally defined as support for allowing a standardized conversion between circuit-switched data and packet-switched data for the transmission on a mobile network.

In FIG. 1, for forward and backward compatibility purposes (for example, to allow PS performance in telecommunications services without sacrificing the requirement for the transparent handling of legacy circuit-switched MS calls), the functionality of a circuit-switched MSC is divided into two functionally distinct entities. One functionally distinct entity is the MSCe 17, which is responsible for call signaling, both for packet and non-packet communications. Signaling can be generally defined as the determination of the routing path from one entity to another entity. Another functionally distinct entity is the MGW 7, which is responsible for the transmission of the bearer traffic. Bearer traffic can be generally defined as the data that is routed by the signaling. The MSCe 17 is the control entity that converts non-PS call signaling (for example, PSTN) to PS call signaling (and vice-versa), and controls the call routing through the PS network 1 and interacts with the MGW 47 of the network 2.

The division of functions into separate functional entities separated by a PS protocol interface facilitates the use of open standards for managing traffic and signals in a PS environment, such as Megaco, SIP, IOS, and circuit-switched signal protocols such as SS7. The present invention facilitates specific functionality within the MSCe, between the MSCe and the MGW and among other MSCe's on other networks. In FIG. 1, network 2 has the LMSDS 12, which includes an HLRe 31, and an MSCe 45, which controls its MGW 47.

The MGW 7 has an interface between the packet environment of the PS network 1 and the circuit switched environment of the PSTN 44 for bearer traffic, when equipped with circuit capabilities. The MGW 7 can provide vocoding and/or transcoding functions to the bearer traffic. The MGW 7 can also provide modem functions to convert digital byte streams to and from audio modem tones placed on circuits, and can provide the capability to terminate Point-to-Point Protocol (PPP) connections. It also provides policy enforcement relative to its activities and resources.

The MGW 7 supports the bearer aspects and bearer switching fabric, tone, announcement and bridging capabilities. In addition, the MGW 7 supports the PS bearer for actual call delivery to other LMSDS's across reference point/interface yy and provides bearer support for connectivity to the PSTN 44. The MGW 7 can use PS protocol signaling from the MSCe 17 for tones and announcements control, for bearer establishment and bridging control functions. In FIG. 1, the LMSDS 11 is employable to provide support for the following interfaces; MGW to radio access network (RAN) voice bearer (27), MGW to RAN circuit data bearer (27), MGW to PSTN Bearer (34), MSCe 17 to MGW 7 signaling (39), and MGW to MGW PS bearer (yy). An access network, such as access network 42 or 43, can comprise a base station, and can be part of the RAN.

The MGW 7 also can have the following capabilities: It terminates bearer channels from the PSTN 44 on interface 34, bearer channels from the radio network on interfaces 27 and media streams from a packet network on interface yy; it supports voice and circuit data media streams on these network terminations; it provides switching of the bearer channels by connecting media streams from one set of network terminations to another set of network terminations; and it converts media in one type of network termination to the format required in another type of network termination.

The MGW 7 has the ability to connect to the PS protocol environment of another PS network, for example, network 2, as well as the circuit-based environment of the PSTN 44. Therefore, the resources provided by the MGW 7, including transcoding resources, can be used to support bearer channels that are contained entirely within the PS environment.

For call initiation from network 1 and network 2, the MSCe 17 and MSCe 45 generally cooperate to find the called party and create a path. The MGW 7, on the other hand, supports conversion of a non-PS traffic bearer to a PS traffic bearer and transports the PS traffic bearer to the final destination and vice versa. In other words, the MGW 7 performs the actual encapsulation between circuit-switched data to packet-switched data, and the MSCe 15 performs the mapping of the routing information between circuit-switched data and packet-switched data. To perform its functions, the MSCe 17 can be capable of communicating with the PSTN network using circuit-switched communications protocols and with an MGW 7 and MGW 47 (for example, through employment of a device control protocol, such as the Megaco protocol), and with Home Location RegistersNisiting Location Registers (for example, using TIA/EIA-41 protocols).

The LMSDS 11 includes network entities HLRe 15, which functions as a home location register emulator, and MSCe 17, which functions as a mobile switching control emulator. Network 1, with its included network entities, and their associated reference points, comprises a wireless PS network. Network 2, with its included network entities, and their associated reference points, also comprises a wireless PS network. The entities HLRe's 15, 41, MSCe's 17, 45 and MGW's 7,47, and reference points/interfaces 38,39, yy, and zz can employ communication protocols based on existing open-standards.

The MSCe 17 and MSCe 45 further have an interworking function or interworking engine. Generally, the interworking engine is employable as a command center mapping of routing information within the MSCe when transmitting data from a circuit-switched network to a packet-switched network. For the purposes of mapping, there can be an interworking engine in the MSCe's of both network 1 and network 2.

The network architecture model depicted in FIG. 1 is a functional block diagram. As used herein, a network entity represents a group of functions, not necessarily a physical device. The physical realization is an implementation issue. A manufacturer can choose a physical implementation of network entities, either individually or in combination, as long as the implementation meets the functional requirements. Sometimes, for practical reasons, the functional network entity is a physical device. The Mobile Station (MS) is an example of a functional entity that is also a physical device.

As used herein, a reference point is a conceptual point that divides two groups of functions. It is not necessarily a physical interface. A reference point can become a physical interface when the network entities on either side of it are contained in different physical devices. A reference point or interface could be standardized, but not necessarily. A reference point exists when two network entities are interconnected through one signaling or bearer stream point. Reference points identify that a logical relationship exists between two network entities. An interface is generally defined across a specific reference point by defining the protocol and data exchanged between the entities. One or more interfaces can be defined for each reference point in the LMSDS system. The points/interfaces 38, 39, yy, zz can employ communications protocols based on existing open-standards.

The LMSDS system 11 comprises a collection of the network entities, the HLRe 15 and the MSCe 17. The LMSDS system 11 can support interfaces using open-standards signal communications protocols at the indicated reference points. These can be the ANSI-41 network signaling, PSTN signaling, media gateway signaling, radio access network signaling, and LMSDS system signaling.

The LMSDS system 11 has the capability of processing mobility management and call control messages from the ANSI-41 network and mobile stations for mobile originated and mobile terminated calls. It controls the establishment of voice bearers between access network 42 and MGW 7, and between access network 43 and MGW 47. The LMSDS 11 and LMSDS 12 also are responsible for establishment of voice bearers between MGW 7 and PSTN 44 and emulate the functionality of the HLRe's 15 and 41, respectively. If requested, the LMSDS 11 performs authentication of mobile stations, and performs call delivery to another LMSDS 12 of network 2 across reference point zz, using an open-standards PS protocol, such as SIP.

The LMSDS systems 11 and 12 perform the call control, mobility management and service management functions to provide support for non-PS (that is, legacy) mobile station networks. The LMSDS systems 11 and 12 are responsible for the control of call origination and call termination of both the circuit and packet switched networks. The LMSDS 11 and 12 terminate the user-network signaling and convert it into the appropriate network-network signaling. The LMSDS 11 and 12 also control the connections for bearer channels in MGW 7 and connections to a base station controller (BSC) (not shown) in the access network 42.

The MSCe 17 is responsible for one or more call control functions. The MSCe 17 uses PS signaling to control the MGW 7 across reference point 39 and to allow the MGW 7 to communicate with MGW 47 of network 2 across reference point/interface yy. The MSCe 17 translates a received E.164 number into an IP address when IP bearer is to be used.

The HLRe 15 is a network entity that supports non-PS Terminals (legacy MS's) in a PS network. The HLRe 15 can have a PS signaling interface. The HLRe 15 supports roaming to the other PS networks. The HLRe 15 also manages the subscriber profile for both voice services (for example, Call Forwarding, Three Way Calling, Message Waiting Notification) and data services (for example, Priority). Subscriber profile information can be accessed from the HLRe 15 or can be downloaded to a serving system as needed.

The HLRe 15 manages subscriber location and/or accessibility information. This includes updating the dynamic subscriber information database with current domain information (for example, MSCe address) and with MS status information (for example, SMS pending flag). The HLRe 15 also interacts with the location database to update or retrieve current location information.

The LMSDS 11 supports the following interfaces or reference points. The MGW to radio access network circuit data bearer (27) is supported. The MGW to PSTN bearer (34), MSCe 17 to MGW 7 signaling (38) and media gateway to media gateway PS bearer (yy) interface or reference points are also supported.

The MGW 7 is employable to provide one or more packet signal switching capabilities. In FIG. 1, the MGW can receive bearer channels from the PSTN on interface 34, bearer channels from the radio network on interfaces 27 and media streams from a packet network on interface yy. The MGW 7 also supports voice and circuit data media streams on these network terminations, provides switching of the bearer channels by connecting media streams from one set of network terminations to another set of network terminations, and converts media in one type of network termination to the format required in another type of network termination.

Open-standards signal communications protocols can be used across its reference points/interfaces. These include, for example, the media gateway control protocol (Megaco) and SIP, a packet-switched data control protocol. Using these standardized reference point/interfaces allow the interworking function to communicate with the PSTN and the MGW of the first mobile network with the entities of the second mobile network in a standardized manner using packet switched protocol.

Media gateway control protocol, also known as H.248 or Megaco, is an open-standards protocol for handling the signaling and session management needed during a multimedia conference. Megaco can be used to communicate signals between the MSCe and the MGW.

Session initiation protocol (SIP) is a request-response PS protocol that establishes call parameters at either end of the communication, and handles call transfer and termination. SIP can be employed when communicating between the MSCe 17 and the MSCe 45; that is, from the first mobile network to the second mobile network, along interface zz. SIP is an open-standards PS protocol and participants are identified by SIP URLs. Requests can be sent through any transport protocol, such as UDP, SCTP or TCP. SIP determines the end system to be used for the session, the communication media and media parameters, and the called party's desire to engage in the communication. Once these are assured, SIP establishes call parameters at either end of the communication, and handles call transfer and termination. SIP is also used for initiating an interactive user session that involves multimedia elements such as video, voice, chat, gaming, and virtual reality.

Like HTTP or SMTP, SIP works in the Application layer of the Open Systems Interconnection (OSI) communications model. The Application layer is the level responsible for ensuring that communication is possible. SIP can establish multimedia sessions or Internet telephony calls, and modify or terminate them. The protocol can also invite participants to unicast or multicast sessions that do not necessarily involve the initiator. Because the SIP supports name mapping and redirection services, it makes it possible for users to initiate and receive communications and services from any location, and for networks to identify the users wherever they are.

Interface yy is a PS bearer interface between MGWs operating using IP. Interface 39 is used for the MGW 7 to communicate to the MSCe 17. Interface 39 provides PS signaling, control bearer resource assignment and bridging from the MSCe 17 to the MGW 7.

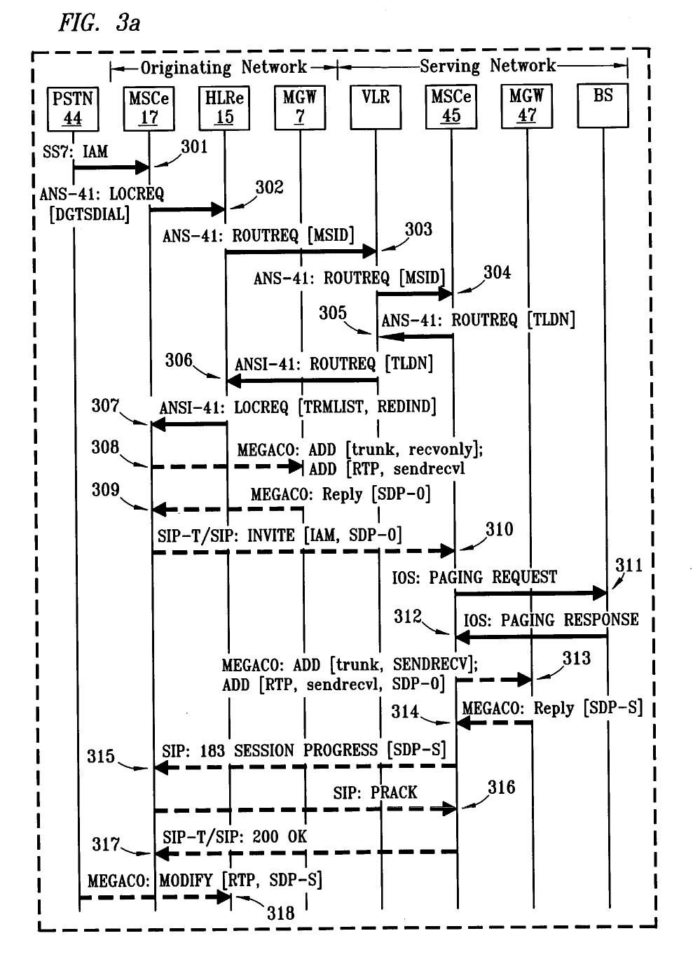

Turning now to FIG. 2, illustrated is an OSI protocol stack for interface zz. Generally, the interworking engine of the MSCe 17 allows for the communication of signals from the interface 13 through the interface zz. Interface zz provides PS signaling control employed by the interface yy. This interface is between MSCes. Interface zz is a signaling interface that is based on SIP-T as defined in IETF-2 and IETF-3. SIP can be employ either TCP as defined in IETF-5, UDP as defined in IETF-6 or SCTP as defined in IETF-4. IP as defined in IETF-7 is used as the network protocol. In FIG. 2, layer 1 represents the physical layer of the OSI protocol stack, and can be a wire, or can be wireless. Layer 2 represents data link layer. Layer 3 represents the network layer. It is within the layer 3 that the SIP is employed.

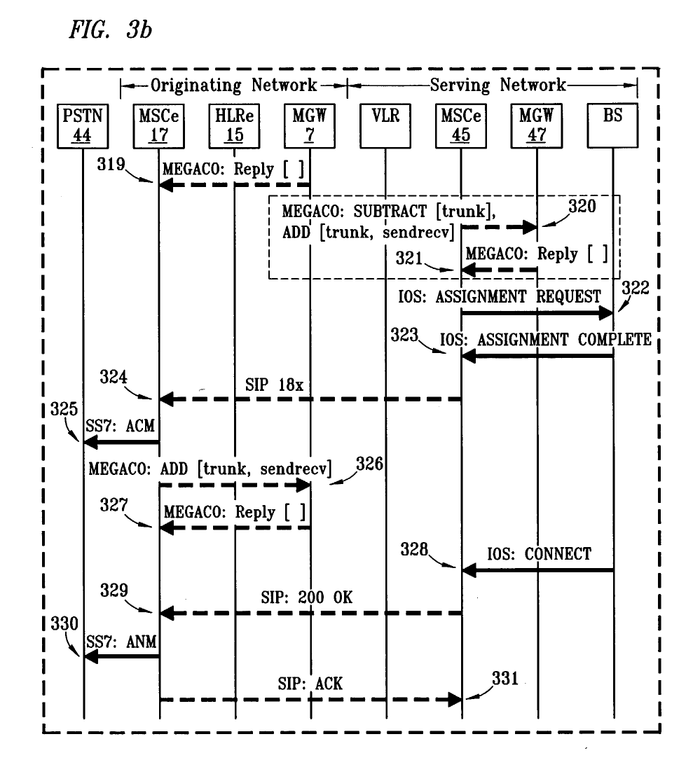

Turning now to FIG. 3, disclosed is an example of call initiation and employment of the MSCe 17 and the MGW 7 to initiate a call from a circuit-switched network to a mobile network using IP routing information. In FIG. 3, the dotted arrows illustrate an interface that uses the open-code Megaco or SIP, thereby allowing for the standardization of communication between the PSTN and the mobile network for packet-switched data. In onehe interworking engine of the MSCe is employed to determine the series of call signals to allow communication between the PSTN and network 2, a mobile network, using packet-switched routing protocols. Generally, the interworking engine encapsulates and maps circuit-switched calls from the PSTN and then forwards them to network 2, a mobile network, in packet-switched format.

In flow 301, a call origination and the dialed MS address digits (that is, directory numbers) are received by the originating MSCe 17 from the PSTN 44 through employment of a circuit control protocol, such as SS7. In flow 302, the originating MSCe 17 sends a LOCREQ to HLRe 15 associated with the MSCe 17. This association can be made through parsing the dialed address digits.

In flow 303, if the dialed MS address digits are assigned to a legitimate subscriber, the HLRe 15 sends a ROUTREQ to the VLR (not shown in FIG. 1) where the MS is registered. In flow 304, the VLR then forwards the ROUTREQ to the current serving MSCe 45. In FIG. 3, the MS has roamed within the domain in the Serving VLR and the MS reported its new location to that VLR through employment of the new serving MSCe 45. In FIG. 3, the Serving VLR can or can not report this change in location to the HLRe. In response to the ROUTREQ, the serving MSCe 45 consults an internal data structure to determine if the called MS is already engaged in a call on this MSCe 45.

In flow 305, the serving MSCe 45 allocates a TLDN (Temporary Local Directory Number) and returns this information to the VLR in the ROUTREQ. The serving MSCe 45 also states the timer TLDNAT (TLDN Acknowledgment Timer). In flow 306, the VLR sends the ROUTREQ to the HLRe.

In flow 307, when the ROUTREQ is received by the HLRe, it returns a LOCREQ to the originating MSCe 17. The LOCREQ includes routing information in the form of the TerminationList parameter, along with an indication of the reason for extending the incoming call in the DMD_RedirectionIndicator parameter. Then, the originating MSCe 17 translates the TLDN to an IP address.

In flow 308, the MSCe 17 establishes a context with an originating MGW 7as defined in IETF RFC (Megaco), a standardized protocol language. The Megaco message comprises two ADD commands. The first ADD command establishes a termination to the PSTN communication channel (for example, DSO on a T1 or E1 line) that corresponds to the incoming IAM (Initial Address Message) with a mode set to Receive Only. The termination is set to this mode for fraud prevention. The second ADD command establishes a termination for a bearer channel using RTP.

In flow 309, the originating MGW 7 replies to the Megaco message, also using Megaco. The reply [IETF-8] message contains the local SDP from the originating MGW 7. The local SDP contains an IP address, a UDP Port number, and a list of Codes that the originating MGW 7 supports for sending and receiving.

In flow 310, the originating MSCe 17 sends an INVITE [IETF-2] message to the Serving MSCe 45 containing the IAM message and the SPD for the originating MGW. The serving MSCe 45 employs the TLDN to make the association with the MSID received in the ROUTREQ message. In flow 311, after receiving an INVITE message, the serving MSCe 45 sends a PAGING REQUEST message to the BS (not shown in FIG. 1) to initiate a mobile terminated call setup scenario.

In flow 312, the BS constructs the Paging Response message, places it in the Complete Layer 3 Information message, and sends the message to the Serving MSCe 45. The BS can request the serving MSCe 45 to allocate a preferred terrestrial circuit. In flow 313, after receiving an INVITE message, the serving MSCe 45 establishes a context with a Serving MGW. The serving MSCe 45 can execute flow 311 and flow 313 substantially simultaneously (that is, they are parallel operations). The Megaco message comprises two ADD commands. The first ADD command establishes a termination to the BS communication channel (for example, DS0 on a T1 or E1 line with a mode set to sendrecv). The second ADD command establishes a termination for a bearer channel using RTP. The SDP-0 contains the IP address and UDP Port number for which the serving MGW is to send the RTP packages. The SDP-O also contains a list of Codes used for Codec negotiation.

In flow 314, the serving MGW replies to the Megaco message. The Reply message contains the local SDP for the serving MGW. The local SDP contains the RTP IP address, the RTP UDP Port number, and a list of Codes that is supported by both the originating MGW and the serving MGW. The list of Codecs can be in preferential order as per RFC 3261, an Internet standard. The Codes list can contain one or more Codes according to RFC 3261.

In flow 315, the serving MSCe 45 sends the originating MSCe 17 a 183 Session Progress [IET-1] message containing SDP-S. In flow 316, the originating MSCe 17 sends a PRACK [IETF-10] message to the serving MSC in response to the 183 Session Progress message. In flow 317, the serving MSCe 45 sends a 200 OK message to the originating MSCe 17 acknowledging the PRACK message. In flow 318, upon receiving the 183 Session Progress message, the originating MSCe 17 sends the originating MGW a Modify [IETF-8] message to provide the RTP termination with the IP address and UDP port number to which to send RTP packages.

In flow 319, the originating MGW 7 selects the first Codec in the list supplied by SDP-S for the RTP bearer channel. If the first Code in the list is no longer available, the Reply message will contain an updated SDP-O, and Codec negotiation between the Originating MGW and the Serving MSCe continue (these steps are not shown in FIGS. 3A or 3B). The originating MGW sends a Reply message to the originating MSCe 17.

In flow 320, if the BS requested a preferred terrestrial circuit in the PAGING RESPONSE message (flow 312) and the serving MSCe 45 can support the terrestrial circuit, the serving MSCe 45 sends the serving MGW a Megaco message to change the established context. The Megaco message comprises a SUBTRACT command for removing the termination to the BS and an ADD command to establish a termination to the BS communication channel using the BS requested preferred terrestrial circuit.

In flow 321, the serving MGW acknowledges the Megaco message with a Reply message. In flow 322, the serving MSCe 45 sends an Assignment Request message to the BS to request assignment of radio resources after receiving a PAGING RESPONSE message (flow 312). In flow 323, after the radio traffic channel and circuit have both been established, the BS sends the ASSIGNMENT COMPLETE message to the serving MSCe 45. In flow 324, after sending the 183 Session Progress message (flow 315), the serving MSCe 45 sends an 18× (for example, 180 ringing) [IETF-1] message to the originating MSCe 17.

In flow 325, the originating MSCe 17 sends an ACM (Address Complete Message) to the PSTN. In flow 326, the originating MSCe 17 sends a modify command to the originating MGW. The modify command modifies the PSTN communication channel to allow for both sending and receiving. In flow 327, the originating MGW acknowledges the Modify message with a Reply message.

In flow 328, the BS sends a CONNECT message to the serving MSCe 45 to indicate that the call has been answered at the MS. At this point, the call is considered stable in the conservation state. Although, in f FIG. 3, the CONNECT message can be received by the serving MSCe 45 anytime after flow 323.

In flow 329, after receiving the CONNECT message for the MS, the serving MSCe 45 sends a 200 OK message to the originating MSCe 17. The message acknowledges that the INVITE of flow 310 has succeeded.

In flow 330, the originating MSCe 17 sends an ANM (Answer Message) to the PSTN.

In flow 331, the originating MSCe 17 sends an ACK (acknowledgment message) to the serving MSCe 45. The ACK message is sent to confirm the reception of the final response (that is, 200 OK).

It is understood that the present invention can take many forms and embodiments. Accordingly, several variations can be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention can be employed without a corresponding use of the other features. Many such variations and modifications can be considered obvious and desirable by those skilled in the art based upon a review of the foregoing description of preferred embodiments. Accordingly, it is appropriate that the appended claims be construed broadly and in a manner consistent with the scope of the invention.

1. An interworking engine, comprising:
an input employable to receive a signal transmitted in circuit control protocol;
a mapper employable to map the circuit-switched signal into a packet data control protocol format;
an output employable to transmit the packet data signal in packet data control protocol format;
an input employable to receive a response to the packet data signal in packet data control protocol;
a mapper employable to map the packet data control protocol signal into circuit control protocol format;
an output employable to transmit a message, in device control protocol, requesting a location indicated by the signal received in circuit control protocol; and
an input employable to receive, in device control protocol, a response to the request for the location indicated by the signal received in the circuit control protocol.

2. The interworking engine of claim 1, wherein the interworking engine is part of a packet control entity.

3. The packet control entity of claim 2, wherein the packet control entity comprises a mobile switching call control entity.

4. The interworking engine of claim 1, wherein the packet call control data protocol comprises SIP.

5. The interworking engine of claim 1, wherein the circuit control protocol comprises SS7 protocol.

6. A media gateway, comprising:
an interface employable to receive a signal in device control protocol format, wherein the signal comprises routing information; and
an interface employable to transmit a response to the signal in packet data control protocol, wherein the response comprises bearer information.

7. A cellular system having a mobile system domain support, comprising:
a first mobile network employing packet data control protocol;
a second mobile network employing packet data control protocol;
a third network employing circuit control protocol;
a packet call control entity within the first mobile network, the packet call entity having an interworking engine employable to receive communication from the third network and forward the communication to the second mobile network through employment of a conversion of circuit control protocol to a packet data control protocol.

8. The cellular system of claim 7, wherein the third network comprises a PSTN network.

9. The cellular system of claim 7, wherein the packet call control entity comprises a mobile switching control center emulator.

10. The cellular system of claim 7, wherein the circuit control protocol comprises SS7 protocol.

11. The cellular system of claim 7, wherein the packet data control protocol comprises SIP protocol.

12. The cellular system of claim 7, wherein the device control protocol comprises Megaco protocol.

13 The cellular system of claim 7, wherein the packet call control entity is employable to communicate with an MGW using the Megaco language.

14. The cellular system of claim 7, wherein the interworking engine is further employable to initiate communication from the second network to the third network through employment of packet and data control protocol.

15. A method of transferring information from a third network to a first network, comprising:
receiving a message from a third network at a first packet call control entity of a first network;
transmitting a message from the first packet call control entity of the first network to an MGW of the first network through employment of a device control protocol;
transmitting a message from the MGW of the first network to the packet call control entity of the first network through employment of a device control protocol;
transmitting a message from the first packet call control entity of the first network to a second packet call control entity of a second network through employment of a packet and data call protocol; and
communicating by the second packet call control entity of the second network with a base station of the second network through employment of an accept trigger message.

16. The method of claim 9, wherein the step of receiving a call from a third network further comprises receiving a call from a circuit-switched network using circuit control protocol.

17. The method of claim 10, wherein the step of receiving a call from a circuit-switched network further comprises employing SS7 protocol.

18. The method of claim 9, wherein the step of employing device control protocol further comprises employing Megaco protocol.

19. The method of claim 9, wherein the step of employing packet and data control protocol further comprises employing SIP protocol.

20. The method of claim 10, wherein the step of employing circuit control protocol further comprises SS7 protocol.

21 The method of claim 9, wherein the step of employing an accept trigger further comprises employing IOS protocol.

22. The method of claim 9, further comprising employing packet data control protocol between the second MSCe of the third network and a base station of the third network.

23. The method of claim 9, further comprising transmitting a subtract trunk message from the second packet call control entity to a media gateway of the third network.

24. A method of initiating a telephone call from a PSTN network to a cellular network, comprising:
receiving a telephone call by a packet call control entity from a circuit-switched network through employment of a circuit control protocol;
employing an interworking engine in the packet call control entity to contact a media gateway through employment of a device control protocol;
employing the media gateway to contact the first packet call control entity through employment of a device control protocol;
contacting a second packet call control entity through employment of packet data control protocol;
contacting a second media gateway from the second packet call control entity through employment of the device control protocol;
replying from the second media gateway to the second data call control entity through employment of device control protocol;
replying from the second packet call control entity to the first packet call control entity through employment of packet and data control protocol; and
transmitting messages to the circuit call control network from the packet call control entity through employment of the circuit control protocol employable by the interworking engine.

25. The method of claim 18, further comprising subtracting signal trunks between the second packet call control entity and the second MGW.

26. The method of claim 18, further comprising adding signal trunks between the second packet call control entity and the second MGW.

27. A system for transferring information from a first network to a second network, comprising:
receiving a message from a circuit-switched network at a first packet call control entity of a first network;
means for transmitting a message from the first packet call control entity of the first network to an MGW of the first network through employment of a device control protocol;
means for transmitting a message from the MGW of the first network to the packet call control entity of the first network through employment of a device control protocol;
means for transmitting a message from the first packet call control entity of the first network to a second packet call control entity of a second network through employment of a packet data call protocol; and
means for communicating by the second call control entity of the second network with a base station of the second network through employment of an accept trigger message.

28. A computer program product for initiating a telephone call from a PSTN network to a cellular network, the computer program product having a medium with a computer program embodied thereon, the computer program comprising:
computer code for receiving a telephone call by a packet call control entity from a circuit-switched network through employment of a circuit control protocol;
computer code for employing an interworking engine in the packet call control entity to contact a media gateway through employment of a device control protocol;
computer code for employing the media gateway to contact the first packet call control entity through employment of a device control protocol;
computer code for contacting a second packet call control entity through employment of packet data call protocol;
computer code for contacting a second media gateway from the second packet call control entity through employment of the device control protocol;
computer code for replying from the second media gateway to the second data call control entity through employment of device control protocol;
computer code for replying from the second packet call control entity to the first packet control entity through employment of packet and data control protocol; and
computer code for transmitting messages to the circuit call control network from the packet call control entity through employment of the circuit control protocol employable by the interworking engine.

29. A processor for initiating a telephone call from a PSTN network to a cellular network, the processor including a computer program comprising:
computer code for receiving a telephone call by a packet call control entity from a circuit-switched network through employment of a circuit control protocol;
computer code for employing an interworking engine in the packet call control entity to contact a media gateway through employment of a device control protocol;
computer code for employing the media gateway to contact the first packet call control entity through employment of a device control protocol;
computer code for contacting a second packet call control entity through employment of packet data control protocol;
computer code for contacting a second media gateway from the second packet call control entity through employment of the device control protocol;
computer code for replying from the second media gateway to the second data call control entity through employment of device control protocol;
computer code for replying from the second packet call control entity to the first packet call control entity through employment of packet and data control protocol; and
computer code for transmitting messages to the circuit call control network from the packet call control entity through employment of the circuit control protocol employable by the interworking engine.
